(19) United States
(12) Patent Application Publication
(10) Pub. No.: US 2019/0342954 A1
(43) Pub. Date: Nov. 7, 2019

(54) MICROWAVE OVEN ACCESSORY DEVICE

(71) Applicant: Nicholas Ladd, Chatham (CA)

(72) Inventor: Nicholas Ladd, Chatham (CA)

(21) Appl. No.: 15/968,701

(22) Filed: May 1, 2018

(51) Int. Cl. H05B 6/64

(52) U.S. Cl. CPC H05B 6/6473

(57) ABSTRACT

A microwave oven accessory device is disclosed herein. The device may include an attachment-body that is configured to mount on the inside of a microwave oven. The attachment-body may include fasteners attached on the exterior of the body. The fasteners may embody hooks, suction cups, and all other conceived means of mounting the body to the inside of the microwave oven. The attachment-body may form a cavity that is configured to retain a reservoir. The reservoir may be configured to contain a liquid, such as water. The device may be disposed on the inside of the microwave when the microwave is in use. The device may provide a reservoir with water for evaporation by the microwave oven for increasing and retaining the moisture of the food being microwaved.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of microwave ovens and more specifically relates to a microwave oven accessory device.

### 2. DESCRIPTION OF RELATED ART

Microwave ovens are household items that utilize high-powered radio waves to excite water molecules in food items. The excited water molecules move rapidly by obtaining energy through the high-powered radio waves. The energy of the excited molecules is transformed into heat, thereby heating the food. When foods lack enough liquids for the high-powered radio waves to excite, heating the food microwave may make the food taste unpleasant. A common solution to the lack of moisture in the food to manually add water to the items that will be microwaved. Another common solution is to fill a cup of water and place cup filled with water onto the microwave along with the food item. Microwaves generally have rotating tables that food items are placed on for even distribution of the high-powered radio waves. Placing a cup filled with water is often burdensome as the water may spill in the microwave due to the rotating table and cause a mess. Further solutions have been explored by integrating moisture retention containers into a microwave oven. These specialized ovens may be cost prohibitive for many users.

U.S. Pat. No. 6,730,895 to Haug-Ki Kim relates to a microwave oven. The described microwave oven includes a microwave oven which is capable of steaming food and cooking food by direct-irradiation of microwave ovens at a same time, and is capable of keeping a cooking cavity clean. A water container is arranged at an upper portion of the cooking cavity to generate steam from water contained in the water container when the water is heated by the microwave ovens. A water supplying guide and a steaming container are arranged at an upper portion of the housing. The steaming container comprises a body and a lid. A food supporting tray with a plurality of steam holes formed therethrough is placed in the body of the steaming container such that the food to be cooked is placed on the food supporting tray. Steam holes formed on a bottom surface of the body are bored in lugs upwardly projected from the bottom surface, and are arranged so as to be eccentric from the plurality of steam holes of the food supporting tray. Thus, water and oil produced from the food placed on the food supporting tray pass through the plurality of steam holes of the food supporting tray and are collected on the bottom surface of the body.

### BRIEF SUMMARY OF THE INVENTION

In view of the foregoing disadvantages inherent in the known microwave oven art, the present disclosure provides a novel microwave oven accessory device. The general purpose of the present disclosure, which will be described subsequently in greater detail, is to provide an efficient and effective microwave oven accessory device.

A microwave oven accessory device is disclosed herein. The device may include an attachment-body that is configured to mount on the inside of a microwave oven. The attachment-body may include fasteners attached on the exterior of the body. The fasteners may embody hooks, suction cups, and all other conceived means of mounting the body to the inside of the microwave oven. The attachment-body may form a cavity that is configured to retain a reservoir. The reservoir may be configured to contain a liquid, such as water. The device may be disposed on the inside of the microwave when the microwave is in use. The device may provide a reservoir with water for evaporation by the microwave oven for increasing and retaining the moisture of the food being microwaved.

A method of using the device is also disclosed herein. The method of using the device may comprise the steps of: a providing a microwave oven accessory device, the microwave oven accessory device may comprise an attachment-body, the attachment-body configured to mount on an inside of the microwave oven, the attachment-body may have a cavity with an upwardly facing aperture; a reservoir, the reservoir may be configured to retain a liquid, the may be reservoir sized and dimensioned to be nested within the attachment-body; a plurality of fasteners, the plurality of fasteners may be disposed on an exterior of the attachment-body, the plurality of fasteners may be configured to retain the attachment-body to the inside of the microwave oven; wherein the device may be configured to contain water for evaporation by the microwave oven; attaching the device to the interior of the microwave oven; removing the reservoir from attachment-body; filling the reservoir with the liquid; and, inserting the reservoir into the attachment-body.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a microwave oven accessory device, constructed and operative according to the teachings of the present disclosure.

FIG. 1 is a top perspective view of the device during an ‘in-use’ condition, according to an embodiment of the disclosure.

FIG. 2 is a front perspective view of the device of FIG. 1, according to an embodiment of the present disclosure.

FIG. 3 is a top view of the device of FIG. 1, according to an embodiment of the present disclosure.

FIG. 4 is an exploded view of the device of FIG. 1, according to an embodiment of the present disclosure.

FIG. 5 is a flow diagram illustrating a method of use for the device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a device and more particularly to a microwave oven accessory device as used to improve the use of microwave ovens.

Generally, the microwave oven accessory device may effectively prevent food items from becoming dry during the re-heating process in a microwave oven. The objective of the device may be to stop food items from losing flavor or texture by being re-heated in a microwave oven. The microwave oven accessory may prevent the wastage of food, thereby saving consumers money. The device may comprise a small attachment for the interior of a microwave oven. The attachment may have a body that is statically mounted on the interior of the microwave. The body may host a refillable reservoir that nests within the body. A user may remove the reservoir and fill it with water. The user may then insert the reservoir into the body that is mounted on the inside of the microwave oven. When the microwave is in operation, water from the reservoir is evaporated. The evaporated water is then disposed across the food, sealing in the flavor and preventing the food from becoming dry.

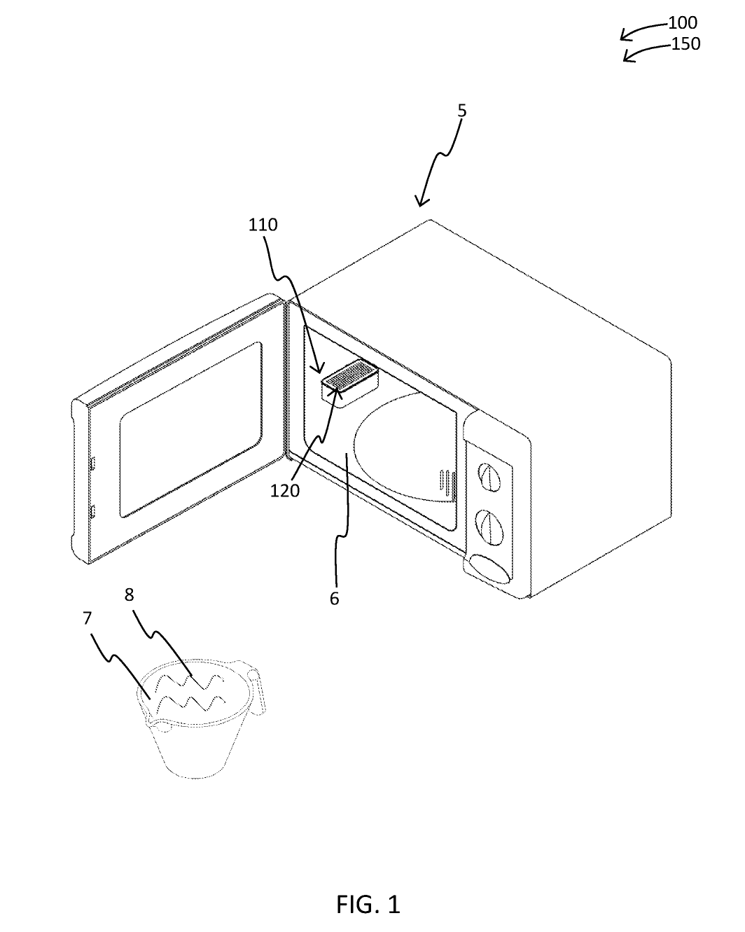

Referring now more specifically to the drawings by numerals of reference, there is shown in FIGS. 1-4, various views of a device 100. FIG. 1 shows a device 100 during an ‘in-use’ condition 150, according to an embodiment of the present disclosure. As illustrated, the device 100 may include an attachment-body 110 configured to mount on an inside 6 of the microwave oven 5. The attachment-body 110 may be two-inches tall and one-inch wide in preferred embodiments. Further embodiments of the device 100 may comprise alternative dimensions. The device 100 may comprise of a microwave oven 5 safe material that is configured to withstand being located on the inside 6 of the microwave oven 5 when the microwave oven 5 is in operation.

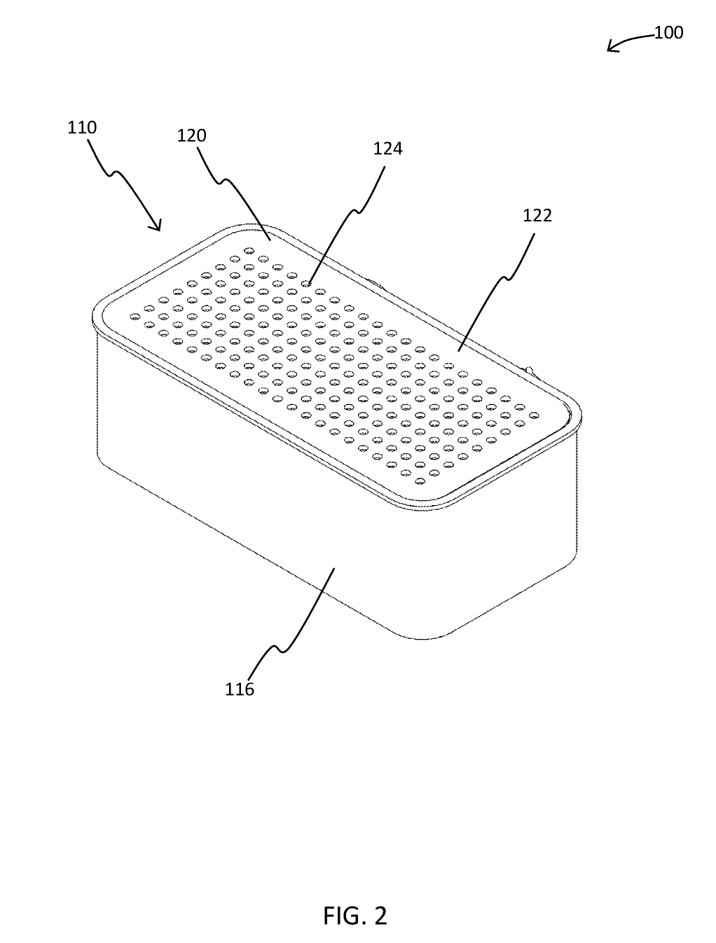

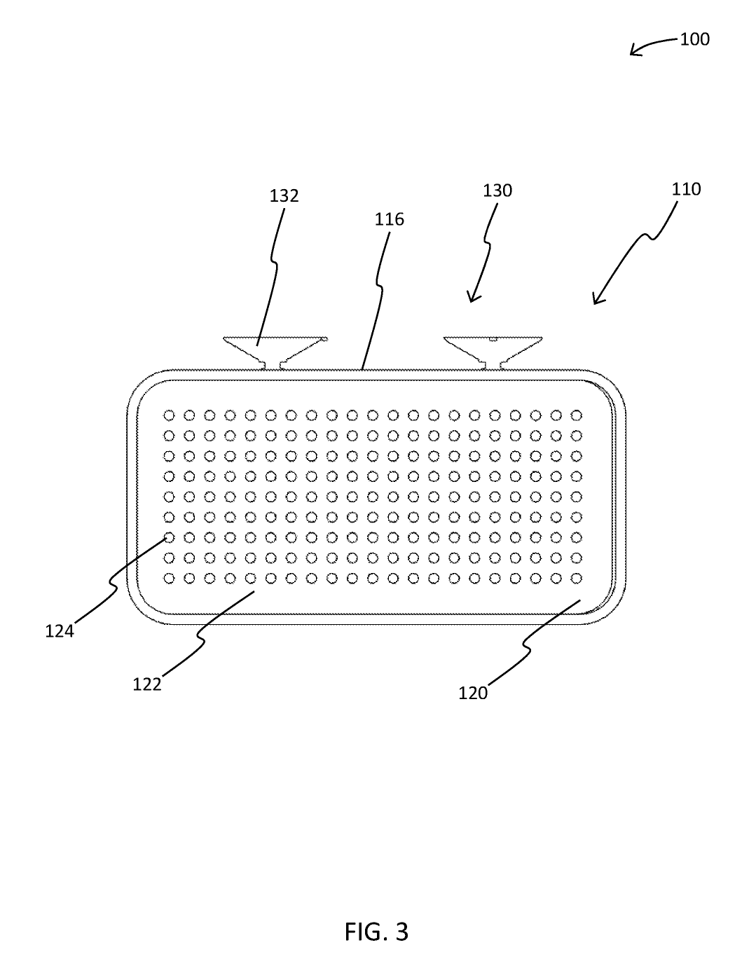

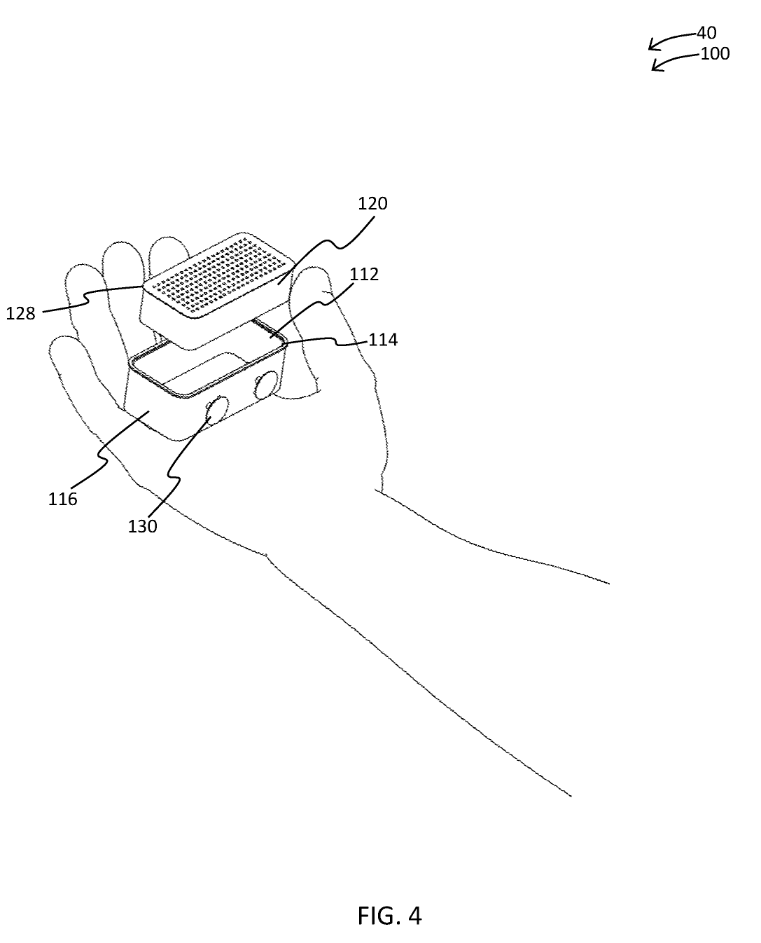

The device 100 may be mounted on any surface on the inside 6 of the microwave oven 5. The attachment-body 110 may have a cavity 112 (FIG. 4) with an upwardly facing aperture 114 (FIG. 4). The device 100 further includes a reservoir 120 (FIG. 2) that is configured to retain a liquid 7. The reservoir 120 may be completely separable from the attachment-body 110. The reservoir 120 may be sized and dimensioned to be nested within the attachment-body 110. The dimensions of the reservoir 120 may be similar in size to that of the upwardly facing aperture 114 and the cavity 112 such that the reservoir 120 may occupy the cavity 112 at least partially when the reservoir 120 is nested within the attachment-body 110. A plurality of fasteners 130 (FIG. 3) may be included with the device 100 and disposed on an exterior 116 (FIG. 2) of the attachment-body 110. The plurality of fasteners 130 may be configured to retain the attachment-body 110 to the inside 6 of the microwave oven 5. The plurality of fasteners 130 may be used for the mounting of the device 100 onto any desired surface on the inside 6 of the microwave oven 5. The device 100 may be configured to contain the liquid 7 for converting the liquid 7 to an evaporated liquid 7 by the microwave oven 5.

FIG. 2 shows a front perspective view of the device 100 of FIG. 1, according to an embodiment of the present disclosure. As above, the device 100 may include attachment-body 110 that may be substantially rectangular. In another embodiment, the attachment-body 110 may be substantially circular. All shapes of the attachment-body 110 may be conceived in further embodiments of the device 100. The attachment-body 110 may have an exterior 116 that defines a cavity 112 (FIG. 4). The cavity 112 of the attachment-body 110 may be of similar size to the reservoir 120 in preferred embodiments. The upwardly facing aperture 114 (FIG. 4) may define a passage for the reservoir 120 to pass through and occupy the cavity 112 (FIG. 4) of the attachment-body 110. The reservoir 120 may occupy the cavity 112 at least partially when the reservoir 120 is nested within the attachment-body 110. As shown, the reservoir 120 is nested within the attachment-body 110. The reservoir 120 is pictured having a top portion 122 that may be configured to prevent the liquid 7 (FIG. 1) from overflowing in the reservoir 120. The top portion 122 may further serve to indicate to what level the reservoir 120 should be filled with the liquid 7. The top portion 122 may comprise of a diffuser 124 to inhibit the overflowing of the liquid 7 contained in the reservoir 120. The diffuser 124 may further serve to aid in evaporation of the liquid 7 and the even distribution of the evaporated liquid 7.

Referring now to FIG. 3 showing a top view of the device 100 of FIG. 1, according to an embodiment of the present disclosure. As above, the device 100 may include the reservoir 120 that comprises a top portion 122 configured to prevent the liquid 7 (FIG. 1) from overflowing in the reservoir 120. The top portion 122 may serve as to indicate what volume of the liquid 7 may be filled in the reservoir 120. The top portion 122 of the reservoir 120 may comprise a diffuser 124 configured to diffuse evaporated liquid 7 evenly. Also shown may be the plurality of fasteners 130 attached to the exterior 116 of the attachment-body 110. The plurality of fasteners 130 may embody any suitable means of fastening to mount the attachment-body 110 to the inside 6 (FIG. 1) of the microwave oven 5 (FIG. 1). In the present embodiment the plurality of fasteners 130 may be suction cups 132. The suction cups 132 may be fashioned as to provide an adequate suction force for retaining the device 100 in a static position on the inside 6 of the microwave oven 5. Alternative embodiments of the plurality of fasteners 130 may include two-sided tape configured to retain the attachment-body 110 to the inside 6 of the microwave oven 5. Further embodiments of the plurality of fasteners 130 may include all means of mounting the attachment-body 110 to the inside 6 of the microwave oven 5.

FIG. 4 shows an exploded view of the device 100 of FIG. 1, according to an embodiment of the present disclosure. As above, the device 100 may include an attachment-body 110 that may be configured to receive the reservoir 120. The reservoir 120 may be sized and dimensioned to be nested within the attachment-body 110. The reservoir 120 may be completely separable from the attachment-body 110. A user 40 may separate the reservoir 120 from the attachment-body 110 for refilling the reservoir 120 with the liquid 7 (FIG. 1), more particularly the reservoir 120 may be configured to be filled with and to retain water 8. The reservoir 120 may further include a lip 128 configured to be gripped by a user 40. The lip 128 may take the embodiment of any structure that may be gripped by a user 40 for removing and replacing the reservoir 120.

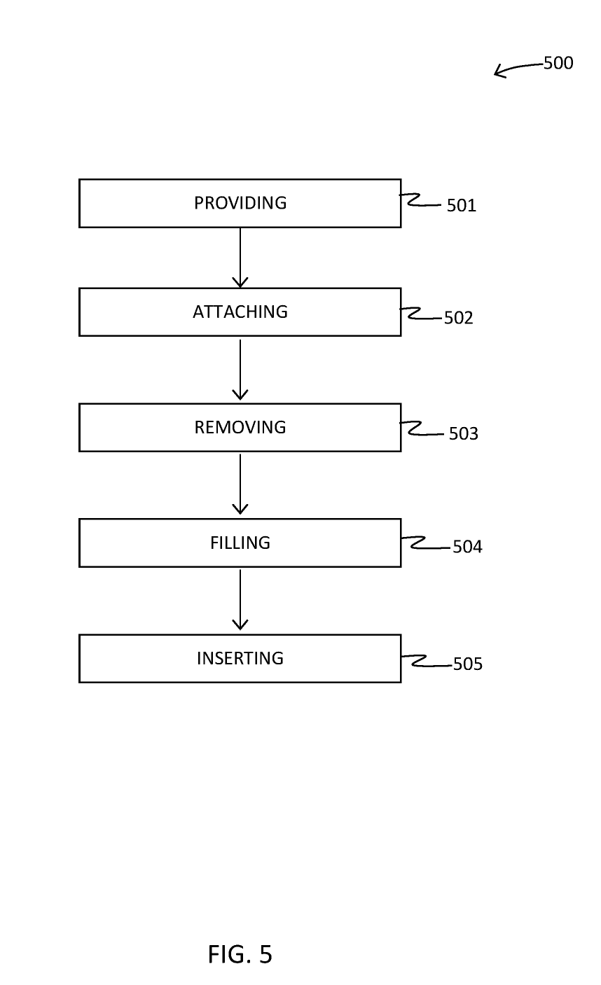

Referring now to FIG. 5, a flow diagram 550 illustrating a method of using a microwave oven accessory device 500, according to an embodiment of the present disclosure. As illustrated, the method of using a microwave oven accessory device 500 may include the steps of: a 501 providing a microwave oven accessory device, the microwave oven accessory device may comprise an attachment-body, the attachment-body configured to mount on an inside of the microwave oven, the attachment-body may have a cavity with an upwardly facing aperture; a reservoir, the reservoir may be configured to retain a liquid, the may be reservoir sized and dimensioned to be nested within the attachment-body; a plurality of fasteners, the plurality of fasteners may be disposed on an exterior of the attachment-body, the plurality of fasteners may be configured to retain the attachment-body to the inside of the microwave oven; wherein the device may be configured to contain water for evaporation by the microwave oven; a step 502, attaching the device to the interior of the microwave oven; a step 503, removing the reservoir from attachment-body; a step 504, filling the reservoir with the liquid; and a step 505, inserting the reservoir into the attachment-body.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for device 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A device for use with a microwave oven, the device comprising:
an attachment-body, the attachment-body configured to mount on an inside of the microwave oven, the attachment-body having a cavity with an upwardly facing aperture;
a reservoir, the reservoir configured to retain a liquid, the reservoir sized and dimensioned to be nested within the attachment-body;
a plurality of fasteners, the plurality of fasteners disposed on an exterior of the attachment-body, the plurality of fasteners configured to retain the attachment-body to the inside of the microwave oven; and
wherein the device is configured to contain water for evaporation by the microwave oven.

2. The device of claim 1, wherein the attachment-body is two-inches tall and one-inch wide.

3. The device of claim 1, wherein the attachment-body is substantially rectangular.

4. The device of claim 1, wherein the attachment-body is substantially circular.

5. The device of claim 1, wherein the attachment-body is configured to be removably attached to the inside of the microwave oven.

6. The device of claim 1, wherein the reservoir further includes a lip that is configured to be gripped by a user.

7. The device of claim 1, wherein the reservoir includes a top portion, the top portion configured to prevent the liquid from overflowing in the reservoir.

8. The device of claim 1, wherein the reservoir includes a diffuser configured to diffuse the evaporated liquid evenly.

9. The device of claim 1, wherein the reservoir is removable from the attachment-body.

10. The device of claim 1, wherein the reservoir is refillable.

11. The device of claim 1, wherein the plurality of fasteners are suction cups.

12. The device of claim 1, wherein the device comprises microwave oven safe material.

13. The device of claim 1, wherein the aperture of the attachment-body is configured to receive the reservoir.

14. The device of claim 1, wherein the attachment-body includes two-sided tape configured to retain the attachment-body to the inside of the microwave oven.

15. The device of claim 1, wherein the plurality of suction cups are sized to provide adequate suction force for retaining the device in a static position.

16. The device of claim 1, wherein the reservoir is configured to retain water.

17. A device for use with a microwave oven, the device comprising:
an attachment-body, the attachment-body configured to mount on an inside of the microwave oven, the attachment-body having a cavity with an upwardly facing aperture,
a reservoir, the reservoir configured to retain a liquid, the reservoir sized and dimensioned to be nested within the attachment-body, and
a plurality of fasteners, the plurality of fasteners disposed on an exterior of the attachment-body, the plurality of fasteners configured to retain the attachment-body to the inside of the microwave oven,
wherein the device is configured to contain water for evaporation by the microwave oven;
wherein the attachment-body is two-inches tall and one-inch wide;
wherein the attachment-body is substantially rectangular;
wherein the attachment-body is configured to be removably attached to the inside of the microwave oven;
wherein the reservoir further includes a lip that is configured to be gripped by a user;
wherein the reservoir includes a top portion, the top portion configured to prevent the liquid from overflowing in the reservoir;
wherein the reservoir includes a diffuser configured to diffuse the evaporated liquid evenly;
wherein the reservoir is removable from the attachment-body;
wherein the reservoir is refillable;
wherein the plurality of fasteners are suction cups;
wherein the device comprises microwave oven safe material;
wherein the aperture of the attachment-body is configured to receive the reservoir;
wherein the plurality of suction cups are sized to provide adequate suction force for retaining the device in a static position;
wherein the reservoir is configured to retain water;

18. A method of using a microwave oven accessory device, the method comprising the steps of: providing a microwave oven accessory device, the microwave oven accessory device may comprise an attachment-body, the attachment-body configured to mount on an inside of the microwave oven, the attachment-body may have a cavity with an upwardly facing aperture; a reservoir, the reservoir may be configured to retain a liquid, the may be reservoir sized and dimensioned to be nested within the attachment-body; a plurality of fasteners, the plurality of fasteners may be disposed on an exterior of the attachment-body, the plurality of fasteners may be configured to retain the attachment-body to the inside of the microwave oven; wherein the device may be configured to contain water for evaporation by the microwave oven; attaching the device to the interior of the microwave oven; removing the reservoir from attachment-body; filling the reservoir with the liquid; and, inserting the reservoir into the attachment-body.
